(19) United States
(12) Patent Application Publication
(10) Pub. No.: US 2005/0089166 A1
(43) Pub. Date: Apr. 28, 2005

(54) Method of applying multiple pipes to assist digital copyright management in a USB storage device

(75) Inventor: Enzo Chen, Yunlin County (TW)

Correspondence Address: BACON & THOMAS, PLLC, 625 SLATERS LANE, FOURTH FLOOR, ALEXANDRIA, VA, 22314, US

(73) Assignee: Institute for Information Industry, Taipei (TW)

(21) Appl. No.: 10/788,373

(22) Filed: Mar. 1, 2004

(30) Foreign Application Priority Data
Oct. 27, 2003 (TW) 92129749

(51) Int. Cl. H04N 7/167

(52) U.S. Cl. 380/201

(57) ABSTRACT

A method of applying multiple pipes to assist digital copyright management in a USB storage device is disclosed. Firstly, a USB storage device is connected to a host for sending a descriptor to the host on demand. Next, the host selects mass storage interfaces in accordance with the descriptor. If the host requires accessing digital signature or private key, it uses random number as coding parameter to produce coded password, and selects a non-1st Bulk output pipe to send the coded password to the USB storage device. Then, the USB storage device selects a non-1st Bulk input pipe for sending an acknowledgement of the coded password back to the host. Finally, if the password is identified right by the host, it uses the random variable as coding parameter to encrypt data and then transmit it through the non-1^{st} Bulk output and input pipes.

### BACKGROUND OF THE INVENTION

1. Field of the Invention

The present invention relates to the technical field of a management method for digital copyright in a USB storage device and, more particularly, to a method of applying multiple pipes to assist digital copyright management in a USB storage device.

2. Description of Related Art

Typically, known digital signature or private key for digital copyright management is stored in a storage device of a file form. For use, the digital signature or private key is read by a terminal and then sent to a digital copyright management server for assuring the authority. Thereafter, digital content can be operated normally. Since the digital signature or private key is stored in a file, a person without authority can easily fetch the file due to such an operation, so the digital signature may be illegally propagated.

To prevent the digital signature be propagated illegally , other means is proposed. For example, a user is requested to connect to a server whenever digital content is used and it makes the user operate inconveniently and increases management cost. In addition, due to digital signature or private key in a file form, it is not controllable that a user may accidentally delete or change the content of the digital signature or private key so as to cause mistakes in operation and authentication.

Therefore, it is desirable to provide an improved method to mitigate and/or obviate the aforementioned problems.

### SUMMARY OF THE INVENTION

The object of the present invention is to provide a method of applying multiple pipes to assist digital copyright management in a USB storage device, which can avoid presenting protected digital signature or private key in a typical file system and thus prevent signature or key damage by accident from a user.

In accordance with a feature of the present invention, a method of applying multiple pipes to assist digital copyright management in a USB storage device is disclosed, which provides a host connecting to the USB storage device through a USB line for performing the digital copyright management. The method includes the steps: connecting the USB storage device with the host for sending a descriptor; sending the descriptor from the USB storage device to the host on demand, wherein the descriptor describes features of a plurality of input and output pipes, thereby transmitting messages associated with the USB storage device's function and capability to the host; selecting mass storage interfaces by the host in accordance with the messages; using random variables as coding parameter to produce coded password when the host requires accessing digital signature or private key and selecting a non-1st Bulk output pipe to send the coded password to the USB storage device; selecting a non-1st Bulk input pipe by the USB storage device for sending an acknowledgement of the coded password back to the host; and using the random variables as coding parameter to encrypt data when the password is identified by the host and transmitting it through the non-1st Bulk output and input pipes.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of applying multiple pipes to assist digital copyright management in a USB storage device in accordance with the invention;

FIG. 2 is a flowchart of a method of applying multiple pipes to assist digital copyright management in a USB storage device in accordance with the invention;

FIG. 3 is an operation of issuing a device descriptor request packet from a host to a USB storage device with device ID equal to 0 in accordance with the invention;

FIG. 4 is an operation of issuing a set address request packet from a host to a USB storage device with device ID equal to 0 in accordance with the invention;

FIG. 5 is an operation of issuing an SCSI-2/UFI command from a host to a USB storage device through an output pipe in accordance with the invention;

FIG. 6 is a data format of a command block wrapper (CBW) packet in accordance with the invention;

FIG. 7 is an operation of a UFI/SCSI-2 command response by USB storage device through a 1st Bulk input pipe in accordance with the invention;

FIG. 8 is a data format of a command status wrapper (CSW) packet in accordance with the invention; and

FIG. 9 is command format of a UFI/SCSI-2 in accordance with the invention.

### DETAILED DESCRIPTION OF THE PREFERRED EMBODIMENT

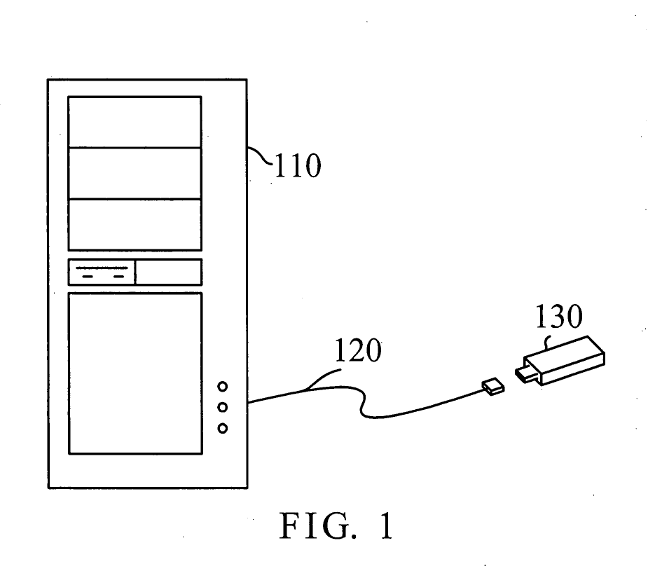

FIG. 1 is a schematic diagram of applying multiple pipes to assist digital copyright management in a USB storage device in accordance with the invention. As shown in FIG. 1, a host 110 connects to a USB storage device 130 through a USB line 120 for performing digital copyright management. The host 110 can be a personal computer, notebook, e-schoolbag or personal digital assistant (PDA). The USB storage device 130 can be a USB flash drive, a mobile device or a language recorder. The host 110 can perform, in accordance with the inventive method, digital copyright management to the USB storage device 130 through the USB line 120.

The USB storage device 130 has five endpoints 0, 1, 2, 3 and 4. Endpoint 0 is provided for a control pipe while endpoints 1 and 2 are provided respectively for 1st Bulk output pipe (OUT-pipe) and input pipe (IN-pipe) of device driver of a mass storage. Both OUT- and IN-pipe have Bulk attribute. Endpoints 3 and 4 are provided respectively for other OUT-pipe and In-pipe when accessing digital signature or private key.

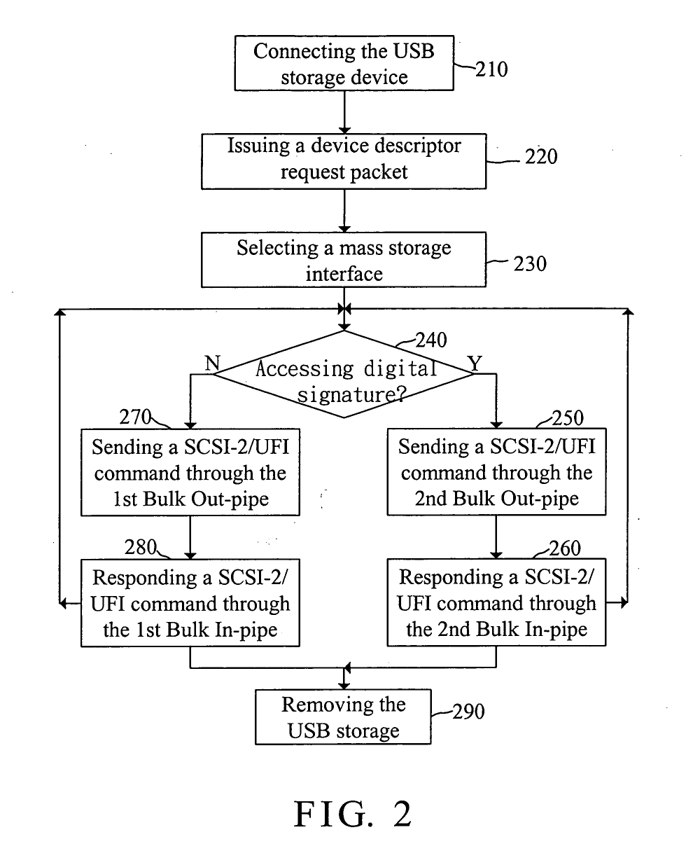

FIG. 2 is a flowchart of the present invention. Firstly, a user connects the USB storage device 130 to the USB line 120 (step S210). Since a USB bus has a hot-plugin feature, when the host 110 detects a pull-up resistor on the USB bus at D− or D+ line, it signals that a low-speed, full-speed or high-speed USB device is connected to the USB bus. Accordingly, when the USB storage device 130 is connected to the USB line 120, the host 110 can detect that the USB storage device 130 is connected to its USB bus.

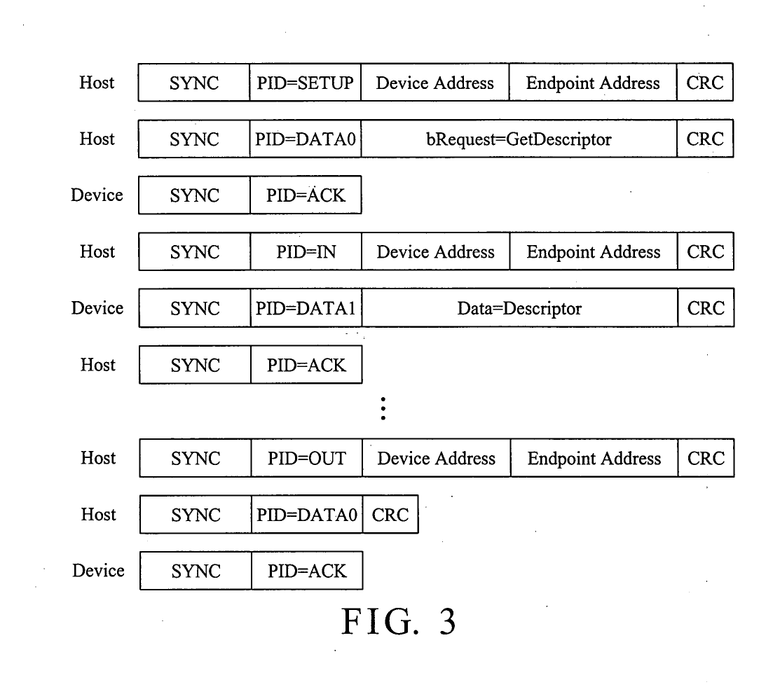

The host 110 firstly issues a bus reset signal to reset the USB storage device 130. The bus reset signal can remains D− and D+ lines at low potential for at least 10 ms. The bus reset signal can force the USB storage device 130 to be in a predetermined device address (address 0). As shown in FIG. 3, the host 110 uses predetermined endpoint 0 for the control pipe to issue a device descriptor request packet to the USB storage device at device address 0, wherein bRequest field in this packet is set to GetDescriptor. The USB storage device 130 sends first 8 bytes of its device descriptor back to the host 110.

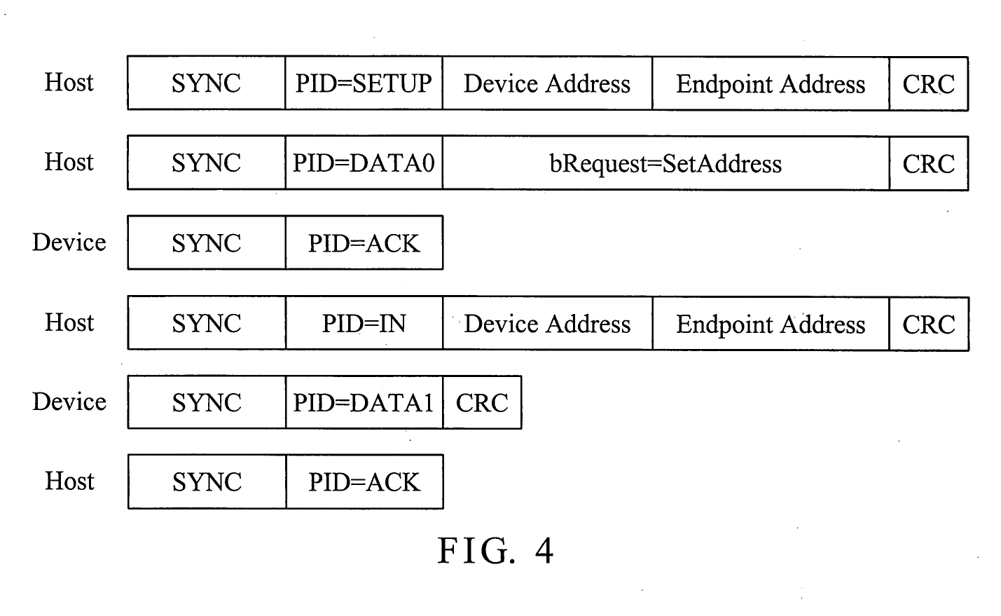

The host 110 issues a set address request packet with a unique address (for example, 0000001b=01h) to the USB storage device 130, wherein bRequest field in this packet is set to SetAddress for setting an address of the USB storage device 130 as 01h. The aforementioned packet transmission between the host 110 and the USB storage device 130 is shown in FIG. 4.

In step S220, the host 110 issues a device descriptor request packet to the USB storage device 130 at address 01h, wherein bRequest field in this packet is set to GetDescriptor. After the device descriptor request packet is received, the USB storage device 130 at address 01h sends data packets 0 and 1 (DATA0 and DATA1) containing the device descriptor back to the host 110. The aforementioned packet transmission between the host 110 and the USB storage device 130 is also shown in FIG. 3, wherein Device Address field is 01h.

The host 110 issues a configuration descriptor request packet to the USB storage device 130 at address 01h, wherein bRequest field in this packet is set to GetConfiguration. After the configuration descriptor request packet is received, the USB storage device 130 at address 01h sends data packets 0 and 1 containing the configuration descriptor back to the host 110. The cited packet transmission between the host 110 and the USB storage device 130 is also shown in FIG. 3, wherein bRequest field is GetConfiguration.

The inventive USB storage device 130 is not only a storage device but also a device having multiple pipes, which can access a mass storage through 1^{st} Bulk output and input pipes and access digital signature and private key through other output and input pipes, in this case, 2^{nd} output and input pipes used. As such, the USB storage device 130 sends the host 110 a bNumEndpoints field of interface descriptor to indicate a value of 04h or more, which represents the USB storage device 130 has at least 4 endpoints in addition to endpoint 0. When endpoint 1 is used as a 1st Bulk OUT-pipe of a mass storage, its endpoint descriptor contains bEndpointAddress field as 01h and bmAttributes field as 02h, which represent that a 1st endpoint is used as an output and has a Bulk attribute. Similarly, when endpoint 2 is used as a 1st Bulk In-pipe of the mass storage, its endpoint descriptor contains bEndpointAddress field as 82h and bmAttributes field as 02h, which represent that a 2nd endpoint is used as an input and has a Bulk attribute.

Further, when endpoint 3 is used as a 2nd Out-pipe for accessing digital signature or private key, its endpoint descriptor contains bEndpointAddress field as 03h, which represent that a 3nd endpoint is used as an output. In this case, the 2nd Out-pipe for accessing digital signature or private key can be one of four transmission types, Bulk, Interrupt, Control, and Isochronous in USB standards. Namely, bmAttributes field can be one of 00h, 01h, 02h and 03h corresponding to the four transmission types. When endpoint 4 is used as a 2nd In-pipe for accessing digital signature or private key, its endpoint descriptor contains bEndpointAddress field as 84h, which represent that a 4th endpoint is used as an input. Similarly, the 4^{th} In-pipe for accessing digital signature or private key can be one of four transmission types, Bulk, Interrupt, Control, and Isochronous in USB standards. Namely, bmAttributes field can be one of 00h, 01h, 02h and 03h.

In step S230, the host 110 selects a mass storage interface in accordance with the descriptor received. Thus, the host 110 can call a device driver of the USB storage device 130 and uses endpoints 1 and 2 of the USB storage device 130, thereby accessing the USB storage device 130. The host 110 selects Bulk-only or CBI (Control, Bulk and Interrupt) protocol in accordance with InterfaceProtocol field of the interface descriptor received, thereby communicating with the USB storage device 130, in this case, using Bulk-only protocol.

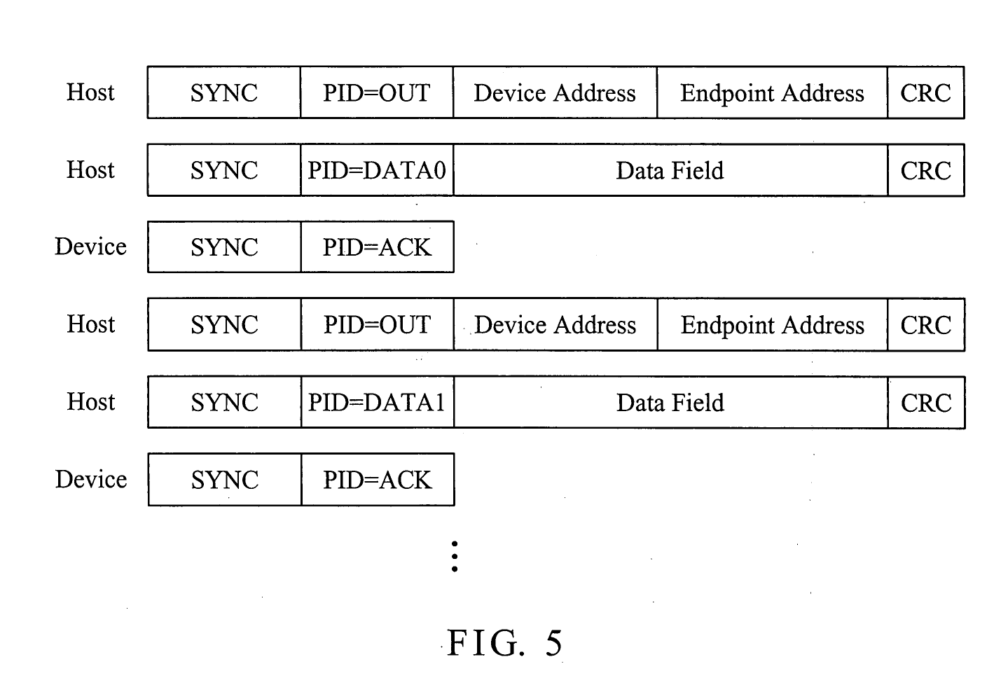

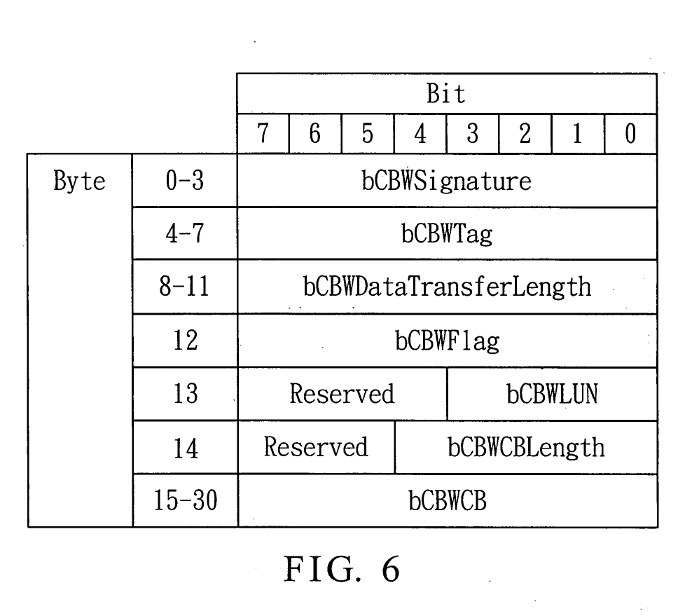

In step S240, it determines whether the host 110 is accessing a typical file or a digital signature or private key in the USB storage device 130. If the host 110 is accessing a typical file, step S270 is performed. In step S270, the host sends a standard block storage command (i.e. SCSI-2/UFI command) through the 1^{st} Bulk Out-pipe. At this point, packet transmission between the host 110 and the USB storage device 130 is shown in FIG. 5, wherein the data fields include a CBW (Command Block Wrapper) packet. The CBW packet has the format shown in FIG. 6, wherein CBWCB field contains a UFI/SCSI-2 command and other fields contain Bulk-only protocol and associated description.

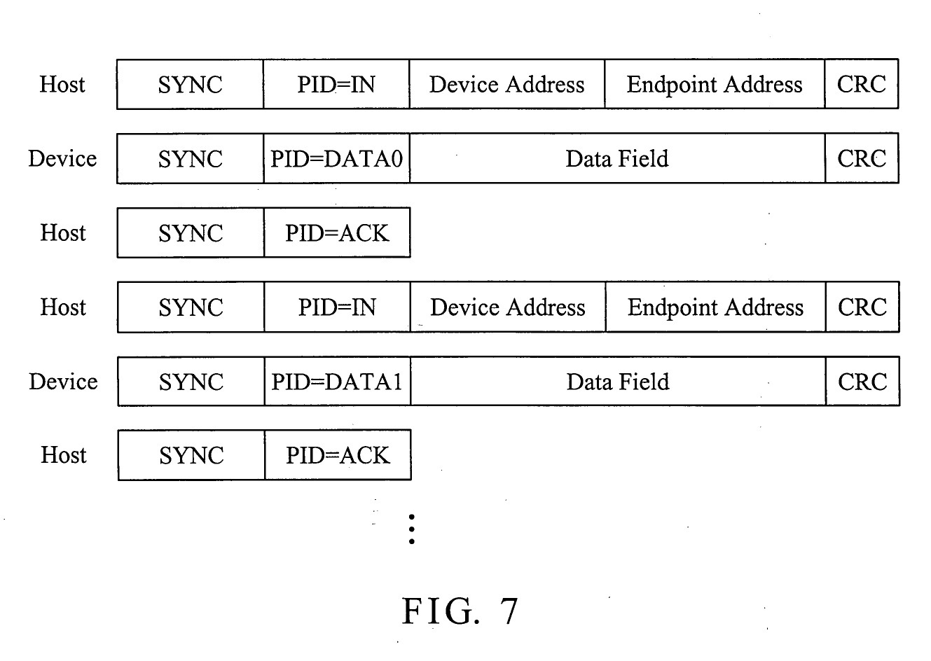

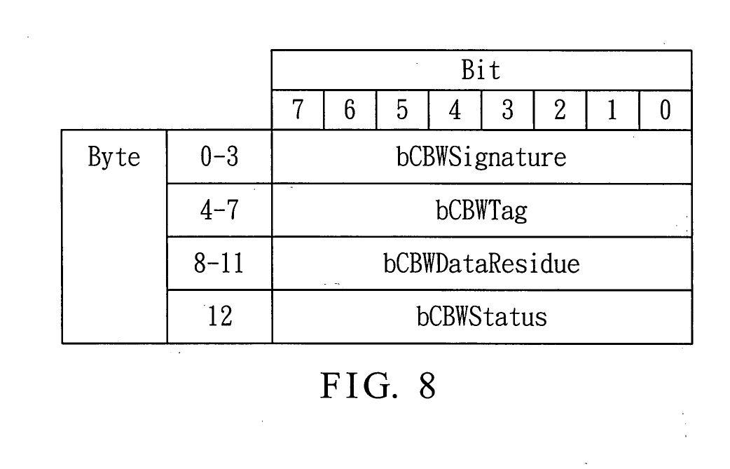

In step S280, the USB storage device 130 obtains the UFI/SCSI-2 command from the CBW packet and accordingly responds control of the host 110 through the 1st Bulk In-pipe. Next, the host 110 controls packet switching for fetching data from the USB storage device 130. At this point, packet transmission between the host 110 and the USB storage device 130 is shown in FIG. 7. Alternately, the host 110 controls packet switching for sending data to the USB storage device 130. At this point, packet transmission between the host 110 and the USB storage device 130 is similar as shown as in FIG. 5. Finally, the USB storage device 130 has to acknowledge each command/data transmitting status, which is complete by sending CSW (Command Status Wrapper) packet to the host 110 on demand. The CSW format is shown in FIG. 8, wherein bCSW Status field is 00h indicative of successful data transmission, 01h indicative of fail and 02h indicative of phase error. After data transmission is complete, the procedure returns to step S240. If the USB storage device 130 is no long used, the procedure returns to step S290 to remove the USB storage device 130.

If the host 110 is accessing a digital signature or private key (step S240), step S250 is performed to call a dedicated device driver for accessing the digital signature or private key through the 2nd output and input pipes. In step S250, the host 110 uses random variable as coding parameter for coding. The coding can be MD5 coding algorithm to thus produce coded password. The host 110 sends the coded password through the 2nd output pipe (OUT-pipe) and the USB storage device 130 sends an acknowledgement of the coded password through the 2nd input pipe (In-pipe) to the host 110. When the password is identified by the host, random variable is used as coding parameter to encrypt data and then transmit it through the 2nd output and input pipes.

At this point, the cited packet transmission between the host 110 and the USB storage device 130 is shown in FIG. 5, wherein the data fields include a CBW packet with format shown in FIG. 6. The CBW packet has a CBWCB field containing UFI/SCSI-2 command or customized command, and other fields containing Bulk-only protocol and associated description. In step S260, the USB storage device 130 obtains the UFI/SCSI-2 command or customized command from the CBW packet and accordingly responds control of the host 110 through the 2^{nd} output and input pipes. When the digital signature or private key is accessed completely, the procedure returns to step S240. If the USB storage device 130 is no long used, the procedure returns to step S290 to remove the USB storage device 130.

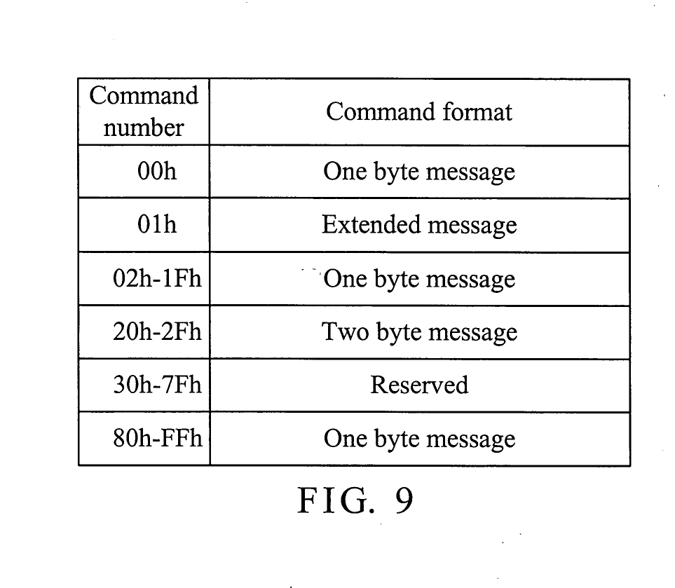

FIG. 9 shows the command fields of UFI/SCSI-2. As shown in FIG. 9, UFI/SCSI-2 command/response protocol defines an operation of basic data storage. Each UFI/SCSI-2 command length is different and thus respective data length is also different. For example, command number 12h indicates Inquiry command which asks the USB storage device 130 to send Logical Unit number; command number 25h indicates Read Capacity command which asks the USB storage device 130 to send Last Logical Block Address and Block Length so that the host 110 can accordingly calculate the capacity of the USB storage device 130.

For a typical USB mass storage device, the host 110 regards it as a disk and thus can recognize the disk's file system, capacity, status and the like based on data block description of the disk. In the host's operating system, such a disk can automatically be mounted in the file system such that the host interprets data of the storage as file data. Otherwise, the host 110 does not regard data that are not transmitted by such a mass storage as a part of the file system, so the data does not appear in the file system, i.e., an application such as file manager cannot open or check such a data. Accordingly, since any inventive data transmission pipe does not use standard protocol pipe of a typical USB mass storage device, so the host's operating system does not regard it as a typical file or mount it in the file system of the operating system. As such, a user cannot access a digital signature or private key to be protected via a typical file operation interface and further damage it. In addition, the invention can process priority control, password check, noise information and the like, which can prevent encrypted data from being wiretapped and stolen.

In view of the foregoing, it is known that the invention applies multiple pipes to access a USB device, where data to be protected is transmitted via the non-1^{st} Bulk output and input pipes, so as to avoid presenting the data including digital signature or private key in a typical file system and further damage it. Also, priority control, password check and noise information are proceeded to prevent encrypted data from being wiretapped and stolen.

Although the present invention has been explained in relation to its preferred embodiment, it is to be understood that many other possible modifications and variations can be made without departing from the spirit and scope of the invention as hereinafter claimed.

1. A method of applying multiple pipes to assist digital copyright management in a USB storage device, which provides a host connecting to the USB storage device through a USB line for performing the digital copyright management, the method comprising the steps:
(A) connecting the USB storage device with the host for sending a descriptor;
(B) sending the descriptor from the USB storage device to the host on demand, wherein the descriptor describes features of a plurality of input and output pipes, thereby transmitting messages associated with the USB storage device's function and capability to the host;
(C) selecting mass storage interfaces by the host in accordance with the messages;
(D) using random variables as coding parameter to produce coded password when the host requires accessing digital signature or private key, and selecting a non-1st Bulk output pipe to send the coded password to the USB storage device;
(E) selecting a non-1st Bulk input pipe by the USB storage device for sending an acknowledgement of the coded password back to the host; and
(F) using the random variables as coding parameter to encrypt data when the password is identified right by the host, and transmitting it through the non-1st Bulk output and input pipes.

2. The method as claimed in claim 1, wherein in step (D), when the host requires accessing a typical file, a 1st Bulk output pipe is selected by the host to send a standard block storage command.

3. The method as claimed in claim 2, wherein in step (D), when the host requires accessing a typical file, the USB storage device sends response of the standard block storage command back to the host through a 1st Bulk input pipe.

4. The method as claimed in claim 3, wherein the standard block storage command is SCSI-2/UFI command.

5. The method as claimed in claim 1, wherein in step (C), the mass storage interfaces are USB standard including configurations and interfaces.

6. The method as claimed in claim 2, wherein the 1st Bulk output pipe is 1st output pipe with Bulk attribute in USB standard.

7. The method as claimed in claim 3, wherein the 1st Bulk output pipe is 1st input pipe with Bulk attribute in USB standard.

8. The method as claimed in claim 1, wherein in step (D), the coding uses MD5 coding algorithm.

9. The method as claimed in claim 1, wherein the non-1st Bulk output pipe is one of 2nd to n-th output pipes of the multiple pipes.

10. The method as claimed in claim 9, wherein the non-1st Bulk output pipe has Bulk attribute.

11. The method as claimed in claim 9, wherein the non-1st Bulk output pipe has Isochronous attribute.

12. The method as claimed in claim 9, wherein the non-1st Bulk output pipe has Control attribute.

13. The method as claimed in claim 9, wherein the non-1st Bulk output pipe has Interrupt attribute.
